(19) United States
(12) Patent Application Publication
(10) Pub. No.: US 2022/0069386 A1
(43) Pub. Date: Mar. 3, 2022

(54) Battery Pack with Integrated Thermal Management

(71) Applicant: L7 Drive Oy, Karjalohja (FI)

(72) Inventor: Daniel Salonen, Karjalohja (FI)

(21) Appl. No.: 17/415,017

(22) PCT Filed: Dec. 17, 2019
(86) PCT No.: PCT/FI2019/050901

§ 371 Date: Jun. 17, 2021

(30) Foreign Application Priority Data
Dec. 17, 2018 (FI) 20186099

(51) Int. Cl. H01M 10/6572; H01M 10/658; H01M 10/653; H01M 10/625; H01M 10/6553; H01M 10/643; H01M 10/6554; H01M 50/213

(52) U.S. Cl. CPC H01M 10/6572; H01M 10/658; H01M 10/653; H01M 50/213; H01M 10/6553; H01M 10/643; H01M 10/6554; H01M 10/625

(57) ABSTRACT

According to an example aspect of the present invention, there is provided a battery pack 100 having integrated thermal management. The battery pack contains a plurality of batteries 110, 112; a base plate 132 affixed to at least one terminal of each battery; a thermoelectric element 150 affixed to the base plate, and thermal insulation 151 on at least two sides of the thermoelectric element 150 adjacent the base plate 132.

### BACKGROUND

Previously thermal management of battery packs has been provided by bulky and often unreliable systems which rely on forced air or complicated liquid cooling systems to remove heat from a battery pack under load or warm a battery pack in cold ambient conditions. Such thermal management solutions were difficult to integrate with battery packs and often were a completely separate system.

Battery packs employed within light electric vehicles, especially those designed for swapping in and out of such vehicles, have provided unique problems with thermal management. The packs are often charged outside of the vehicles and as such both the battery chargers and vehicles themselves required thermal management systems. Further, battery packs designed to be easily swapped between devices often have a rather high rated current and thus produce more heat during charging and use. Despite this increased demand for thermal management, it is difficult, if not impossible to employ liquid cooling or any compressor based active cooling in swappable battery packs.

### SUMMARY OF THE INVENTION

With ever increasing demand for electric vehicles throughout the world an efficient and simple thermal management system which can be employed across a wide range of ambient conditions is needed. Swappable battery systems which provide for cost effective battery solutions have also complicated thermal management.

Embodiments of the present invention provide for a cost effective and mechanically simple integrated thermal management system for a battery pack by providing a thermoelectric element affixed to a plate of the battery pack.

The invention is defined by the features of the independent claims. Some specific embodiments are defined in the dependent claims.

According to a first aspect of the present invention, there is provided a battery pack having integrated thermal management comprising: a plurality of batteries; a base plate affixed to at least one terminal of each battery; a thermoelectric element affixed to the base plate, and thermal insulation on at least two sides of the thermoelectric element adjacent the base plate.

### BRIEF DESCRIPTION OF THE DRAWINGS

FIGS. 1A and 1B illustrate battery packs in accordance with at least some embodiments of the present invention.

FIG. 2 shows a battery pack having an insulating casing surround the batteries according to certain embodiments of the present invention.

FIG. 3 illustrates a battery pack employing a compressive construction according to at least some embodiments of the present invention.

FIG. 4 shows at least one method of affixing batteries within a battery pack according to at least some embodiments of the present invention.

### EMBODIMENTS

Embodiments of the present invention provide for an integrated thermoelectric element to heat and cool a battery pack. Such an integrated thermal management solution proves especially beneficial as many embodiments avoid the use of convective heating or cooling and thus allow for use in a wider range of ambient conditions. For example, a battery pack according to at least some embodiments of the present invention could maintain optimal thermal conditions for the batteries even when ambient conditions range from −40° C. to +60° C.

By insulating the thermoelectric element on at least two sides, battery packs having integrated thermal management according to embodiments of the present invention prevent unwanted heat transfer and allow for efficient use of a thermoelectric element.

Furthermore, embodiments of the present invention allow for thermal insulation of the majority of the battery pack such that only the heat, created by charging or discharging the battery, needs to be removed by the thermoelectric element. Similarly, heating of the battery pack in cold ambient conditions is made easier as heat is not lost to the outside environment.

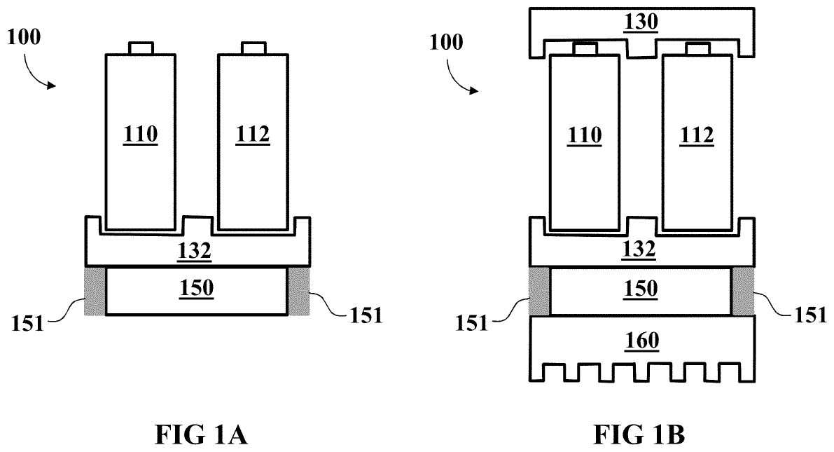

As seen in FIG. 1A at least some embodiments of the present invention provide for a battery pack 100 having integrated thermal management. The battery pack comprises a plurality of batteries 110, 112 which are affixed to a base plate 132 via at least one terminal of each battery. A thermoelectric element 150, for example a Peltier element, is affixed to the base plate 132 and provides for the transfer of thermal energy between the batteries and the environment. Thermal insulation 151 is provided on at least two sides of the thermoelectric element 150 adjacent the base plate 132. The thermal insulation 151 employed in at least some embodiments of the present invention also provides for electrical insulation.

As discussed herein the batteries may be affixed to the base plate 132, or the base plate 132 may be affixed to the batteries 110, 112 in a variety of fashions. In certain embodiments the batteries 110, 112 are adhered to the base plate 132 using adhesive, in certain embodiments the batteries 110, 112 are compression fit within spaces of the base plate 132. Some embodiments rely on compression between two plates to secure the batteries 110, 112 as will be discussed below.

FIG. 1B illustrates certain embodiments of the present invention which further comprise a heat exchanger 160 affixed to the thermoelectric element 150 opposite the base plate 132 such that the thermal insulation 151 is affixed between the base plate 132 and heat exchanger 160. Within such embodiments the thermal insulation ensures that the base plate 132 and heat exchanger 160 are thermally insulated if not isolated. Within some embodiments the base plate 132 and heat exchanger 160 are thermally and electrically insulated, for example they may be electrically insulated such that any potential voltage experienced during operation of the battery pack 100 would not cause an arc between the heat exchanger 160 and base plate 132. Certain embodiments may be constructed such that the base plate 132 and heat exchanger 160 are electrically insulated such that the highest rated voltage of the battery pack 100 would not cause a breakdown of the insulation between the base plate 132 and heat exchanger 160.

At also shown within FIG. 1B at least some battery packs according to embodiments of the present invention further comprise a top plate 130 affixed to each battery 110, 112 opposite the base plate 132. Within certain embodiments the top plate 130 is non-conductive. For example the top plate 130 may be constructed from non-conductive materials, such as plastic.

Within certain embodiments of the present invention it is the negative terminals of each battery 110, 112 which are affixed to the base plate 132. Such an arrangement provides for better thermal conductivity between the batteries and the base plate 132. In some embodiments this thermal conductivity can be further enhance by providing a base plate 132 which is conductive, for example a base plate 132 which is constructed from a conductive material, such as aluminum or copper. A conductive base plate 132 also provides for a common terminal for the batteries 110, 112 and battery pack 100 in certain embodiments.

At least some embodiments of the present invention provide for a battery pack wherein all of the batteries are connected in parallel. That is, all of the negative terminals are conductively connected and all of the positive terminals are conductively connected. As an example, all of the negative terminals of the batteries may be conductively connected via a base plate and the positive terminals may be conductively connected via fuses to a common positive terminal or terminals.

Some embodiments of the present invention do not employ thermal insulation. For example, a battery pack which is designed to be inserted into a vehicle or device, the battery pack may be very minimal. The battery pack of FIG. 1A, without the thermal insulation would prove very convenient for use in a device designed to accept the pack. The exposed terminals of the battery could contact terminals within the device in order to power said device. Further, a device designed to use battery packs according to at least some embodiments of the present invention may provide for a heat exchanger on the device. For example, a door to a battery compartment of the device may be closed around the battery pack and thus secure the batteries in conductive contact with the device and the thermoelectric element in thermal contact with a heat exchanger.

According to some embodiments of the present invention the thermal insulation 151 is provided on at least two sides of the thermoelectric element 150. For example the thermal insulation may be affixed between the base plate 132 and heat exchanger 160 on four sides of the thermoelectric element 150. The thermal insulation may be on a side of the thermoelectric element such that it directly contacts the element or provides insulation to that side of the element in some fashion. For example the insulation may be separated from a side of the thermoelectric element by an air gap or an adhesive and sill be considered on a side of the thermoelectric element. Certain embodiments employ thermal insulation on three sides of the thermoelectric element. Some embodiments cover at least two sides of the thermoelectric element which are not facing the batteries or opposite the side facing the batteries.

Within certain embodiments of the present invention the thermal insulation 151 is affixed between the base plate 132 and heat exchanger 160 such that no portions of the thermoelectric element are exposed to ambient conditions.

Regardless of the manner in which insulation is provided, battery packs according to embodiments of the present invention allow for a more efficient thermal management by limiting thermal energy transfer from or to the environment. For example, when cooling of the battery pack in a hot environment at least some embodiments ensure that the battery pack is well insulated and thus limit the amount of heat which must be removed from the pack.

As an example, within at least some battery packs according to the present invention, only around 1-3% of the current transferred from or to the batteries is converted to heat. In such situations the amount of ambient heat which is prevented from entering the battery area is much greater than the heat retained due to battery operation. In very well insulated embodiments, the thermoelectric element will only need to remove the heat generated by the batteries. In certain solutions, for example when employed in light electric vehicles, battery packs employing thermal managements systems as discussed herein may require less than 100 W to maintain an optimal operating temperature, even in a worst case scenario.

Similar to cooling the battery pack in hot environments, a well-insulated battery pack will require less heating to maintain proper battery temperature in cold environments. When employing a thermoelectric element according to the present invention it is possible to thermally insulate the battery pack due to the reliable and efficient nature of the thermal management. Without employing the teachings herein, a well-insulated battery pack would be at risk of overheating. In contrast, embodiments of the present invention prevent overheating without concern that a fan will fail and the battery pack will experience thermal runaway even when the battery pack is well-insulated.

According to certain embodiments of the present invention the thermoelectric element can be operated to heat or cool the batteries and/or battery pack. For example, in certain embodiments the polarity of the voltage supplied to the thermoelectric element may be reversed such that in one direction heat is transferred out of the pack and in another direction heat is transferred into the pack. Thus heating and cooling the battery pack.

Convective heat transfer is avoided in at least some embodiments of the present invention. Through insulation of the battery and thermoelectric element and other means convection can be avoided and thus a more precise and efficient control of the batteries thermal condition can be provided by the thermoelectric element.

Within certain embodiments of the present invention the base plate 132 is described as being affixed to the terminal of the battery, however the base plate 132 may also be affixed to a side or one end of the battery. For example, in a battery having both terminals on one end, the base plate 132 may be attached to the end opposite the terminals.

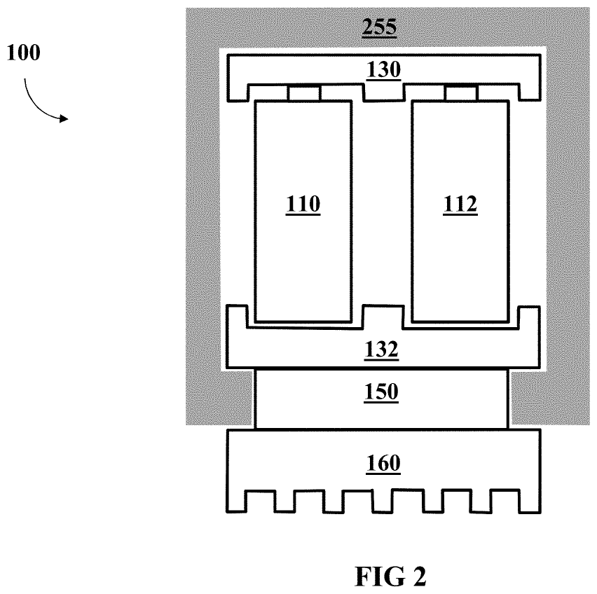

FIG. 2 illustrates a battery pack 100 according to at least some embodiments of the present invention wherein the thermal insulation 255 comprises a casing formed around the batteries 110, 112. While FIG. 2 only provides a cross sectional view, the thermal insulation 255 provides for at least five walls on all sides of the batteries which are not covered by the base plate 132. As illustrated, the thermal insulation 255 is still present between the heat exchanger 160 and base plate 132 in the area of the thermoelectric element 150. Within at least some embodiments this casing encloses the batteries 110, 112. Within certain embodiments this casing surrounds the batteries 110, 112 or at least substantially surrounds the batteries 110, 112.

As seen in FIG. 2, an optional top plate 130 is illustrated. The top plate 130 may be eliminated in at least some embodiments, including embodiments wherein the thermal insulation 255 helps to secure or secures the batteries 110, 112 to the base plate 132. Thermal insulation 255 according to at least some embodiments may be the only element securing the batteries 110, 112 within the battery pack.

Within at least some embodiments wherein the batteries 110, 112 are at least partially enclosed by thermal insulation the insulation is provided by a casing which is removable to allow access to the batteries 110, 112 of the battery pack. For example the thermal insulation 255 of FIG. 2 may be comprised of multiple elements. Alternatively, the thermal insulation 255 may be one element configured to be elastically deformable such that it may be removed and reattached. A thermal insulation of the battery pack casing may be of a different composition to the thermal insulation which insulates the thermoelectric element.

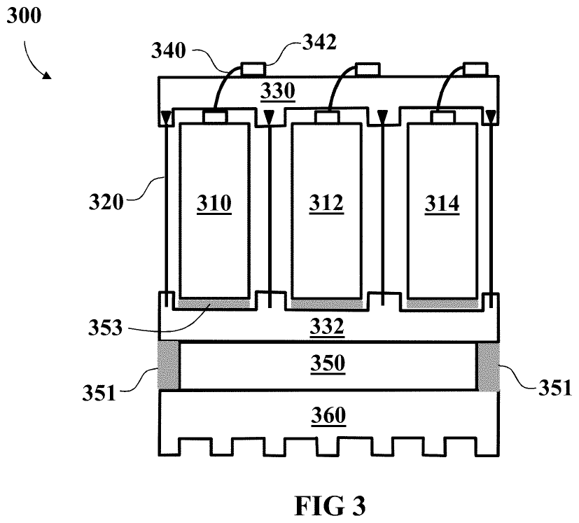

FIG. 3 illustrates a battery pack 300 according to an embodiment of the present invention wherein the batteries 310, 312, 314 are affixed to the base plate 332 via a thermally and electrically conductive adhesive 353. At least some embodiments require only adhesive to keep the batteries adhered to the pack. The embodiment of FIG. 3 also illustrates a similar arrangement of the thermoelectric element 350, heat exchanger 360 and thermal insulation 351.

Within certain embodiments having a similar arrangement to the battery pack 300 of FIG. 3, there is a compound 353, such as an adhesive and/or thermal compound, between the base plate 332 and the at least one terminal of each battery 310, 312, 314. This compound may provide for a variety of effects. For example, the compound may serve to provide a seal, thermal conductivity and/or electrical conductivity. A sealing compound could be useful in sealing an electrical connection, such as a soldered connection, between the batteries 310, 312, 314 and the base plate 332. Such a seal would prevent corrosion and could also increase vibration resistance of the battery pack. At least some embodiments of the present invention provide for a thermally and/or electrically conductive compound 353 which ensures a thermal and/or electrical connection between the batteries 310, 312, 314 and the base plate 332.

As also illustrated within FIG. 3, at least some battery packs 300 according to the present invention comprise at least one compression element 320, such as a fastener, for example a screw, bolt or threaded rod, configured to compress the batteries 310, 312, 314 between the base plate 332 and top plate 330. Within certain embodiments the batteries 310, 312, 314 are compression fit within the battery pack 300 such that the base plate 332 and top plate 330 are affixed to the batteries 310,312,314 via compression. Within some embodiments this compression is the primary or sole means of affixing the batteries within the battery pack.

Further illustrated within FIG. 3 are fuse elements 340 conductively connected to the terminals of each battery 310, 312, 314 opposite the base plate 332 according to certain embodiments of the present invention. These fuse elements 340 may be connected to fuse blocks 342 or terminals atop the top plate 330 within some battery packs.

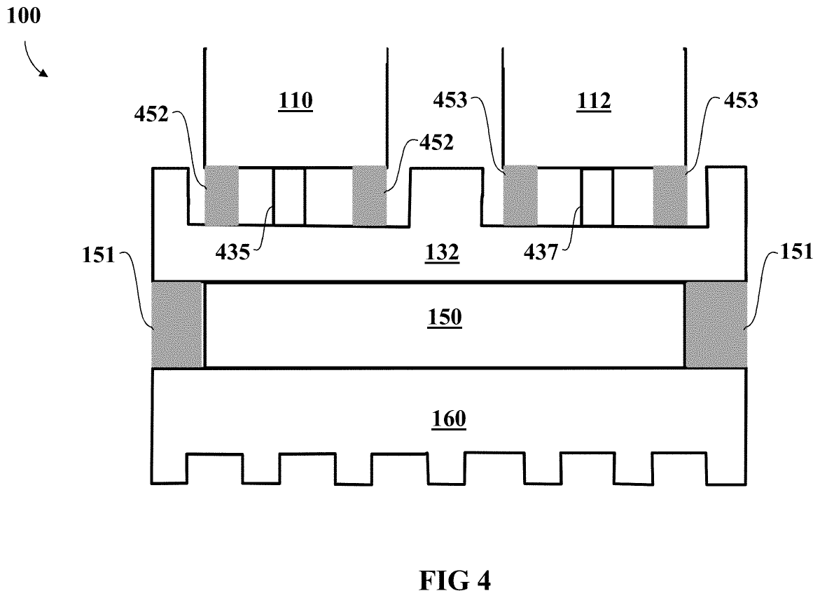

FIG. 4 shows a battery pack 100 according to some embodiments of the present invention further comprising conductive elements 435, 437 conductively connecting the base plate 132 and at least one terminal of each battery 110, 112. As also illustrated, at least some battery packs 100 further comprise a compound 452, 453, disposed between the base plate 132 and the at least one terminal of each battery 110, 112, such that there is space for the conducting elements 435, 437 between the at least one terminal of each battery 110, 112 and base plate 132.

The battery packs illustrated within FIG. 4 also comprise a thermoelectric element 150 and heat exchanger 160 as previously discussed regarding embodiments of FIGS. 1-3. The thermal insulation 151 also illustrated within FIG. 4 may be constructed of the same compound 452, 453 as employed between the batteries 110, 112 and base plate 132.

As FIG. 4 illustrates a cross section of the battery pack the compound 452, 453 is shown as two blocks on opposing sides of the conductive elements 435, 437. The compound 452, 453 may take on a variety of shapes, for example it may be disposed in a circle so as to seal the conductive element and protect it from corrosion. The compound 452, 453 may also be disposed at only a select number of points around the conductive elements 435, 437, for example it may places as four blocks or points equally spaced around the conductive elements 435, 437.

Each of the figures provided herein is a cross section of a battery pack according to the present invention. It should be understood that battery packs according to the present invention may comprise a plurality of batteries in a wide variety of arrangements. For example the two or three batteries of the figures may constitute one row of many within the battery pack. For example, as per FIG. 3, there may be five rows of three batteries such that there are fifteen batteries within the pack.

At least some embodiments of the present invention further comprise a controller conductively connected to the thermoelectric element in order to control heat transfer of the thermoelectric element. The controller may be powered by the batteries themselves in order to provide for thermal control of the battery pack separate from a device employing the battery pack. The controller may be configured to maintain a temperature of the batteries within an optimal range, for example between a maximum and minimum operating temperature of the batteries. The controller may determine temperature via an internal temperature sensor or, within at least some embodiments; an additional temperature sensor is affixed somewhere within or on the battery pack, for example on at least one of the batteries. Certain controllers are configured to control the thermoelectric element based on an external and internal monitored temperature.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### REFERENCE SIGNS LIST

100 Battery Pack

110, 112 Batteries

130 Top Plate

132 Base Plate

150 Thermoelectric Element

151, 255 Thermal Insulation

160 Heat Exchanger

300 Battery Pack

310-314 Batteries

320 Compression Elements

330 Top Plate

332 Base Plate

340 Fuse

342 Fuse Block

350 Thermoelectric Element

351 Thermal Insulation

353 Compound

360 Heat Exchanger

435, 437 Conducting Elements

452, 453 Compound

1. A battery pack comprising:
a plurality of batteries;
a base plate affixed to at least one terminal of each battery;
a thermoelectric element affixed to the base plate, and
thermal insulation on at least two sides of the thermoelectric element adjacent the base plate,
wherein the plurality of batteries are conductively connected in parallel at least partially via the base plate.

2. The battery pack of claim 1, further comprising a heat exchanger affixed to the thermoelectric element opposite the base plate such that the thermal insulation is affixed between the base plate and the heat exchanger.

3. The battery pack of claim 1, wherein the thermal insulation is affixed between the base plate and heat exchanger on four sides of the thermoelectric element.

4. The battery pack of claim 1, wherein the thermal insulation comprises a casing surrounding the batteries.

5. The battery pack of claim 1, wherein the thermal insulation is affixed between the base plate and heat exchanger such that no portions of the thermoelectric element are exposed to ambient conditions.

6. The battery pack of claim 1, wherein the batteries are affixed to the base plate via a thermally and electrically conductive adhesive.

7. The battery pack of claim 1, further comprising a top plate affixed to each battery opposite the base plate.

8. The battery pack of claim 1, further comprising a compound, between the base plate and the at least one terminal of each battery.

9. The battery pack of claim 1, further comprising conducting elements conductively connecting the base plate and the at least one terminal of each battery.

10. The battery pack of claim 8, further comprising a compound which is disposed between the base plate and the at least one terminal of each battery, such that there is space for the conducting elements between the at least one terminal of each battery and base plate.

11. The battery pack of claim 1, wherein the base plate is constructed from a conductive material, such as aluminum.

12. The battery pack of claim 1, wherein the top plate is constructed from a non-conductive material, such as plastic.

13. The battery pack of claim 1, further comprising at least one compression element, such as a fastener, configured to compress the batteries between the base plate and top plate.

14. The battery pack of claim 1, further comprising fuse elements conductively connected to the terminals of each battery opposite the base plate.

15. The battery pack of claim 1, wherein the negative terminals of each battery are affixed to the base plate.

16. The battery pack of claim 2, wherein the batteries are affixed to the base plate via a thermally and electrically conductive adhesive.

17. The battery pack of claim 5, wherein the batteries are affixed to the base plate via a thermally and electrically conductive adhesive.

18. The battery pack of claim 8, wherein the compound is an adhesive.

19. The battery pack of claim 8, wherein the compound is a thermal compound.

20. The battery pack of claim 18, further comprising a compound which is disposed between the base plate and the at least one terminal of each battery, such that there is space for the conducting elements between the at least one terminal of each battery and base plate.
